(19) United States
(12) Patent Application Publication
(10) Pub. No.: US 2006/0010797 A1
(43) Pub. Date: Jan. 19, 2006

(54) Method and device for increasing the opening size of a window

(76) Inventors: Jay F. Halsey, Mount Arlington, NJ (US); Sergio Aranguren, Hillsdale, NJ (US)

Correspondence Address: SILLS CUMMIS EPSTEIN & GROSS P.C., ONE RIVERFRONT PLAZA, IP DEPARTMENT, NEWARK, NJ, 07102, US

(21) Appl. No.: 10/889,847

(22) Filed: Jul. 13, 2004

(51) Int. Cl. E06B 3/32

(52) U.S. Cl. 52/204.51

(57) ABSTRACT

In a method and apparatus for increasing the opening size of a window, the apparatus including a window side frame having an aperture therethrough and a shim coupled to the window side frame, wherein a window pane unit may be moved to a fully open position without the locking mechanism impinging on a lower portion of the window upper sill as a result of the window pane unit being forced into a forward position by impingement upon the shim.

### FIELD OF THE INVENTION

The present invention relates to the field of windows and particularly to a method and device for increasing the opening size of single and/or double hung windows.

### BACKGROUND OF THE INVENTION

Due to changes in and increased concern about fire safety and fire regulations, many towns, counties and fire safety boards and agencies have added to or modified regulations relating to the opening size requirements for windows for purposes of [ingress and] egress. The changes have been implemented in part to ensure a minimum size opening for windows for purposes of allowing individuals to safely exit a structure when faced with a dangerous condition such as a fire. These changes have come about as a result of the concerns of insurance companies, and regulatory and safety agencies in minimizing the risk to life and limb, and have been designed utilizing the increased knowledge about fire safety, the amount of time available to evacuate a building and the average size of adults who would potentially be exiting a building through a window in case of a fire or other dangerous situation.

While implementation of and adherence to these new regulations have added some burdens to homeowners. The overall improvement in safety has more than outweighed the difficulties. Moreover, the new regulations usually do not require any modifications to existing structures, but rather are focused on new construction and where replacement windows are being installed by the building owner. To conform with the new building codes as implemented by the new regulations, the installation of new windows must meet certain requirements. Any new windows being installed must be of a certain minimum size and have a certain minimum sized opening.

Unfortunately, the regulations that are imposed are not uniform throughout the United States and different geographic locations often have different requirements.

While newly manufactured windows may be and are usually designed to conform to the most strict of the regulations, there are often situations where the replacement window does not conform to the regulations. For example, the existing window that is in stock may be out of specification due to recent regulatory changes, a party would like to conform their existing windows to the new regulations without having to replace the entire window, the window manufacturer may not want to undertake the great expense of changing an existing window design, or there may be a constraint on the size of the window based on the placement or location of the window or the design specifications of the structure.

One of the most common reason for a window not conforming to the regulatory specifications is that the opening size is not of a sufficient size. As a result of this situation many otherwise adequate windows can no longer be used or must be redesigned. The present invention solves this problem by providing for an increase in the opening size of the window without having to reconstruct the window, engage in costly modifications to the window structure or totally replace the window.

### SUMMARY OF THE INVENTION

The present invention provides a device and method for increasing the opening size of a single and/or double hung window. The present invention allows a window to be opened further than was previously possible and, therefore, allows windows that previously were not in compliance with or did not conform to the new or revised egress [and ingress] regulations to achieve compliance with and conform to such regulations.

The present invention provides for the displacement of the upper edge of a lower sash panel in an direction interior to a room using a wedge and side channels in the window opening frame so as to bypass an edge of the upper sash panel and an upper portion of the opening frame of the window, thereby providing for the expanded movement of the lower sash toward the upper portion of the opening frame. The present invention also provides a method for achieving such expanded movement of the lower sash by positioning a wedge along at least one side portion of the window frame or an inner portion of the upper sash and providing expanded or angled channels in the side portions of the window frame, such that the wedge will force the window panel away from the upper sash toward the interior of the room and the window panel will be realigned with and follow the expanded or angled channels in the side portion of the window frame. Alternatively or additionally, the expanded movement may be accomplished for the upper sash using a wedge on a side portion of the window frame or an outer portion of an inner window and providing expanded or angled channels in the side portions of the window frame, such that the wedge will force the window panel away from the lower sash toward the exterior of the structure and the window panel will be realigned with and follow the expanded or angled channels in the side portion of the window frame.

The present invention provides an offset element or shim for coupling to a portion of the window frame and an expansion, cutting, melting or grinding device for expanding or angling the side channels to allow movement of the upper portion of the lower sash in an inward direction and/or the bottom portion of the upper sash in an outward direction when the widows are moved toward their maximal open position. This allows the upper edge of the lower sash and/or the locking mechanism located at the upper portion of the lower sash to bypass the lower portion of the upper sash frame and the upper portion of the upper sash frame and allows the lower sash to be raised further than otherwise would be possible. This allows the lower edge of the upper sash and/or the locking mechanism located at the lower portion of the upper sash to bypass the upper portion of the lower sash frame and the lower portion of the lower sash and allows the upper sash to be lowered further than otherwise would be possible. This incremental increase in the amounts that the lower sash may be raised and the upper sash may be lowered will provide for certain windows to satisfy the opening requirements of the new or revised regulations where previously they would not have complied.

A similar increase in opening size is also possible where the offset element is coupled to a portion of the window frame and an expansion device is utilized to expand or angle the side channels to allow movement of the bottom portion of the upper sash in a direction outward from the structure or an upper portion of the lower sash in a direction inward to the room. This incremental increase in the amount that the upper sash may be lowered or the lower sash may be raised will also provide for certain windows to satisfy the opening requirements of the new or revised regulations where previously they would not have complied.

The offset element may be in the form of a shim, plug, wedge, ramp or other similar structure that forces the window in the desired direction. For example, it will force the lower sash toward the interior of the structure and/or it will force the upper sash toward the exterior of the structure. The offset element may be made of plastic, wood, metal, ceramic, a combination of any of these materials or some other rigid or semi-rigid material. The offset element may be located at the interior surface of the window frame that is parallel to the window pane and slightly below the uppermost position to which the window may be raised. An offset element may be located at one or more than one location on the window frame. For example, an offset element may be located at each of the sides of the window frame. The offset element may be positioned such that a narrower part of the offset element is located at a position where it will make first contact with the window when the interior window is moved in an upward direction or when the exterior window is moved in a downward direction. For example, where the offset element is a wedge, the offset element is positioned such that the point of the wedge faces downward where the interior window is the window being moved for expanded opening.

The expansion device may be a cutting, grinding, melting or other instrument for removing or dislocating a portion of each of the side channels in which the relevant window is positioned for upward and/or downward movement.

To assist with and ensure that the removal or dislocation of the portion of the channel is accurate and adequate to provide for the desired result of additional movement of the relevant window, the present invention provides for a template to be used in conjunction with the expansion device. The template may be positioned at the relevant location to provide for the desired expansion of a channel and the expansion device may then be used in conjunction with the template which will provide guidance for proper expansion of the channel.

Alternatively, in place of an expansion or angling of the side channels, the window sash may be fitted with one or more pins that remain in a retracted position until the window sash is moved into a new vertical alignment by the offset element. The repositioning of the vertical alignment of the window sash causes the retraction of a first set of one or more pins used to position and align the window sash in a first vertical position from the side channel of the window frame and the extension of a second set of one or more pins used to position and align the window sash in a second vertical position that is further interior to the structure for the lower sash and that is further exterior to the structure for the upper sash into the side channel of the window frame.

The pins may be in the shape of a latch, a bar, a peg, a wedge or any other shape that could be positioned in a side channel of a window frame.

Alternatively, pins may be utilized to maintain the window sash in correspondence with side channels of the window frame. The side channels may be angled toward the interior of the structure near an upper section of the window frame and may guide the pins in an inward direction, thereby forcing the window sash inward so as to avoid impingement of the locking mechanism upon a lower section of the upper portion of the window frame prior to maximal opening of the window.

### BRIEF DESCRIPTION OF THE DRAWINGS

FIG. 1 shows a front view of a frame ramp disposed on a window frame according to a first embodiment of the present invention.

FIG. 2 shows a cross-sectional side view, along points a-a, of the frame ramp of FIG. 1 disposed on a window frame.

FIG. 3a shows a side view of the frame ramp of FIG. 1.

FIG. 3b shows a front view of the frame ramp of FIG. 1.

FIG. 4 shows the window frame of FIG. 2, with an expanded side channel.

FIG. 5 shows a front view of a frame ramp disposed on a window frame according to a second embodiment of the present invention.

FIG. 6 shows a cross-sectional side view, along points a-a, of the frame ramp of FIG. 5 disposed on a window frame.

FIG. 7a shows a side view of the frame ramp of FIG. 4.

FIG. 7b shows a front view of the frame ramp of FIG. 4.

FIG. 8 shows the window frame of FIG. 6, with an angled side channel.

### DETAILED DESCRIPTION

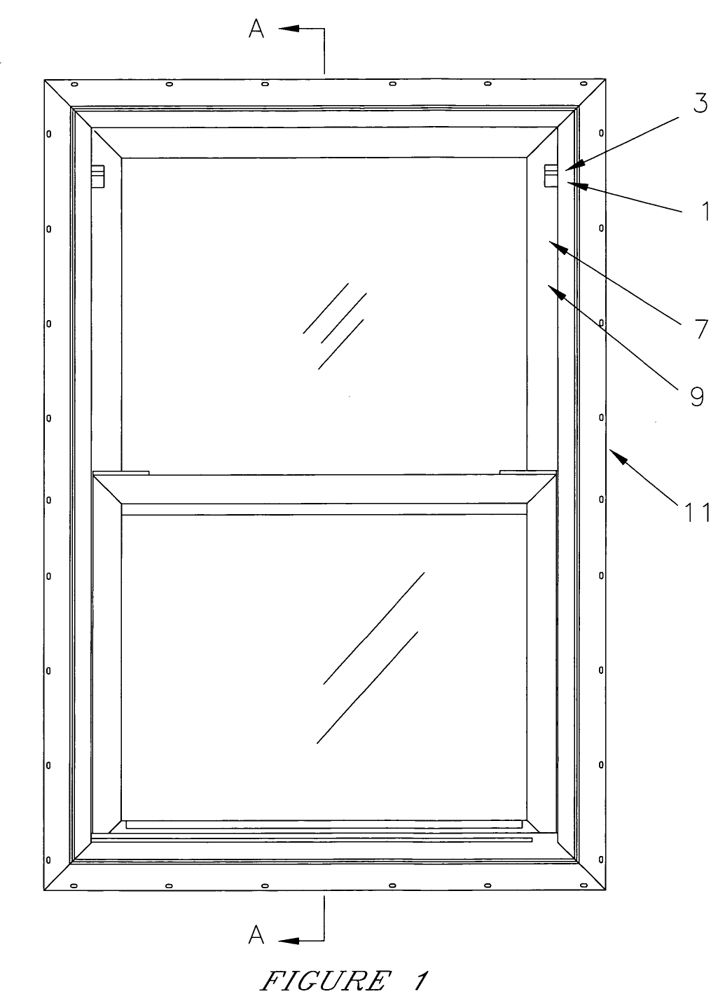

Turning to FIG. 1, there is shown a front view of a frame ramp disposed on a window frame according to a first embodiment of the present invention. The frame ramp 1 is in the form of a plug 3 having a rectangular shape and is disposed on an interior facing portion 7 of a side frame 9 of a window 11.

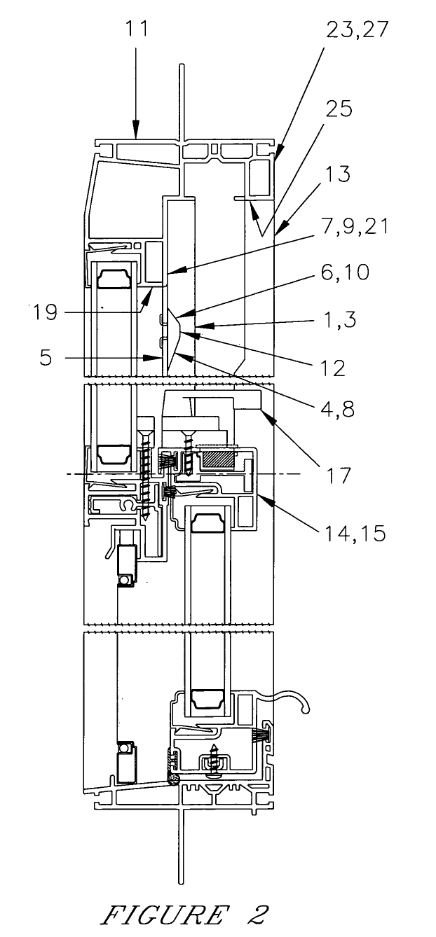

In FIG. 2 there is shown a cross-sectional side view, along points a-a, of the frame ramp of FIG. 1 disposed on a window frame. The frame ramp 1 is in the form of a plug 3 having a lower end 4 with an angled first surface 8 and an upper end 6 with an oppositely angled second surface 10, such that the first surface 8 and the second surface 10 form a peak 12. The plug 3 may be inserted into an opening 5 formed in the interior facing portion 7 of the side frame 9 of the window 11. The plug 3 is located at an upper portion 13 of the side frame 9 such that upon impingement of the upper portion 14 of the window pane unit 15 on the lower end 4 of the plug 3 during its upward movement, the window pane unit 15 is forced toward the interior of the structure as it moves up the first angled surface 8, thereby providing for clearance of the locking mechanism 17 from a bottom portion 19 of the lower portion 21 of the upper frame 23 of the window 11 and allowing the window pane unit 15 to be raised the maximal distance until the locking mechanism 17 on the window pane unit 15 abuts a bottom portion 25 of the upper portion 27 of the upper frame 23 of the window 11.

The plug 3 may be included as part of the side frame 9 of the window 11 during manufacture or may be a retrofit unit that is field installed. To install the plug 3, the opening 5 may be made in the side frame 9 of the window 11 by drilling or punching a hole in the side frame 9. The plug 3 may be inserted into the opening 5 by applying pressure to the front of the plug 3.

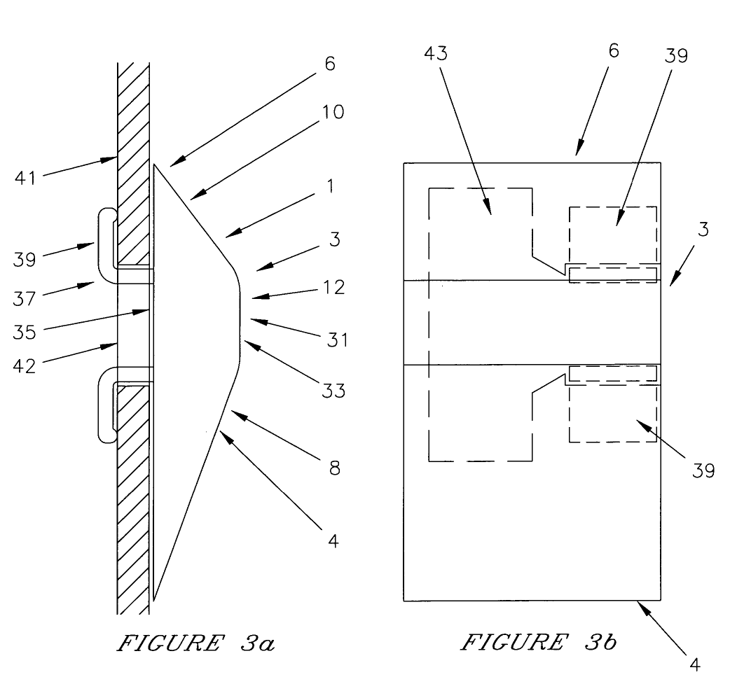

Looking now at FIG. 3a there is shown a side view of the frame ramp of FIG. 1. The frame ramp 1 is in the form of a plug 3 that includes a front section 31 having a face portion 33 and rear portion 35, and a back section 37 that extends rearward from the rear portion 35 of the plug 3. The face portion includes the lower end 4 with the angled first surface 8 and the upper end 6 with the oppositely angled second surface 10, such that the first surface 8 and the second surface 10 form the peak 12. The back section 37 of the plug 3 includes two tabs 39 disposed on a side edge of the plug 3. The two tabs 39 extend from the rear portion 35 a distance approximately equal to the width of the side sash wall 41, bend at approximately a 90° angle and run parallel to the rear portion 35 of the plug 3. The interior 42 of the back section 37 of the plug 3 is hollow. The two tabs 39 maintain the plug 3 in its insertion position in the opening 5 in the side sash wall 41.

In FIG. 3b there is shown a frontal view of the frame ramp of FIG. 1. The frame ramp 1 in the form of a plug 3 has a rectangular shape with the upper end 6 disposed at the top of the side frame 9 of the window 11 and the lower end 4 disposed at the bottom of the side frame 9 of the window 11. The side frame 9 of the window 11 includes a slot 43 having a length slightly exceeding the distance between the ends of the two tabs 39. The slot 43 narrows in the direction of the opening 5 and is notched to provide an engaging edge to prevent movement of the plug 3 toward the slot 43 after being moved into the opening 5.

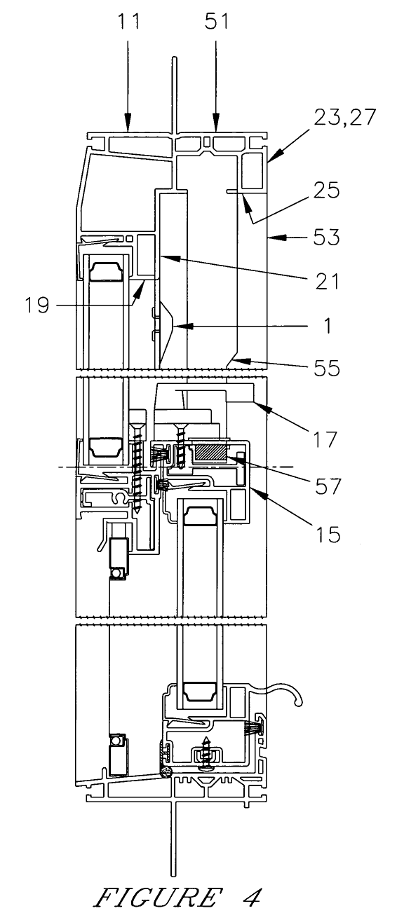

Turning now to FIG. 4, there is shown the window frame of FIG. 2, with an expanded side channel. The frame 51 of the window 11 includes side portions 53 (only one shown) that each include a channel 55 for guiding the movement of the window pane unit 15. The window pane unit 15 includes extensions or pins 57 that are each positioned within a channel 55 to ensure stability of the window pane unit 15 and proper movement of the window pane unit 15 along the channels 55. The pins 57 also prevent the window pane unit 15 from intruding within the structure through the force of the wind or other external forces. Each channel 55 is of uniform width from the bottom of the side portions 53 of the frame 51 until a point adjacent to the frame ramp 1, at which point the channels 55 increase in width to accommodate a forward movement of the window pane unit 15 toward the interior of the structure. The forward movement of the window pane unit 15 allows the locking mechanism 17 to avoid impinging upon the bottom portion 19 of the lower portion 21 of the upper frame 23 of the window 11 and allows the window pane unit 15 to be raised the maximal distance until the locking mechanism 17 on the window pane unit 15 abuts a bottom portion 25 of the upper portion 27 of the upper frame 23 of the window 11.

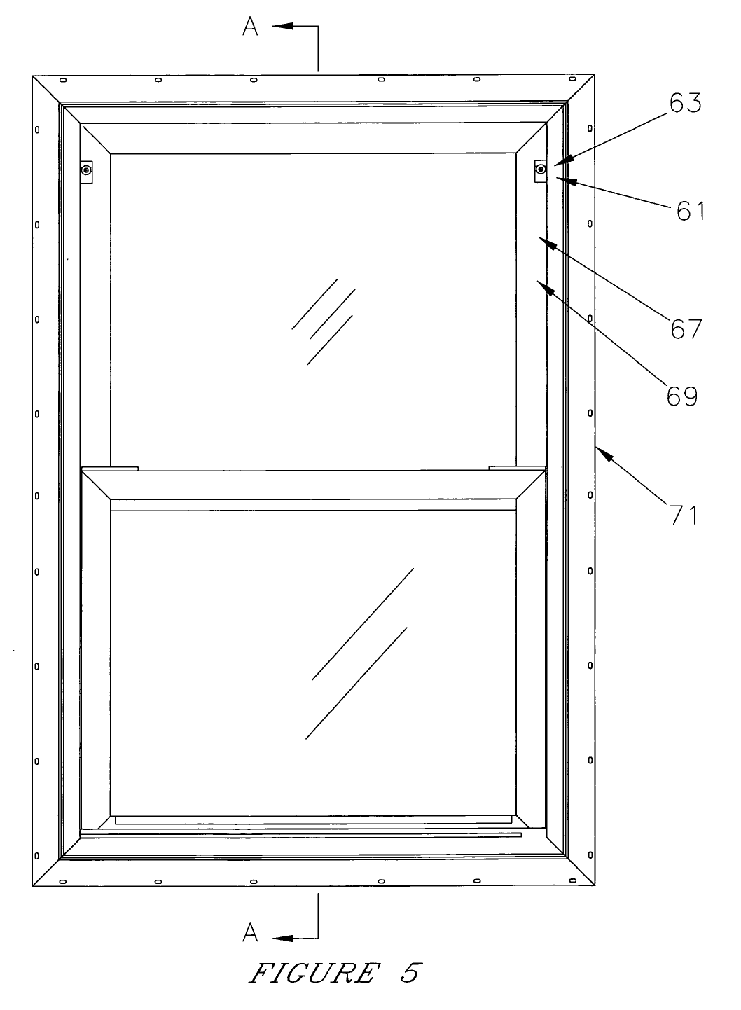

In FIG. 5, there is shown a front view of a frame ramp disposed on a window frame according to a second embodiment of the present invention. The frame ramp 61 is in the form of a shim 63 having a rectangular shape and is disposed on an interior facing portion 67 of a side frame 69 of a window 71.

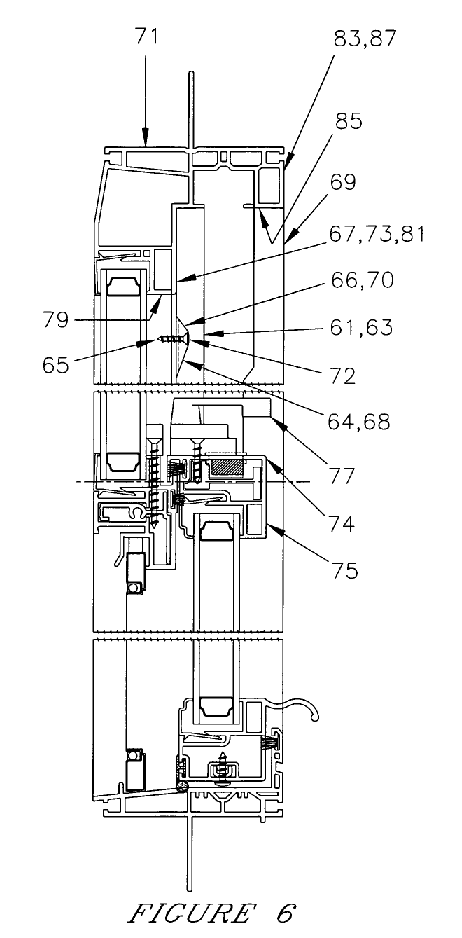

In FIG. 6 there is shown a cross-sectional side view, along points a-a, of the frame ramp of FIG. 5 disposed on a window frame. The frame ramp 61 is in the form of a shim 63 having a lower end 64 with an angled first surface 68 and an upper end 66 with an oppositely angled second surface 70, such that the first surface 68 and the second surface 70 form a peak 72. The frame ramp 61 may be coupled to the interior facing portion 67 of a side frame 69 of a window 71 using a screw 65. The shim 63 is located at an upper portion 73 of the side frame 69 such that upon impingement of the upper portion 74 of the window pane unit 75 on the lower end 64 of the shim 63 during its upward movement, the window pane unit 75 is forced toward the interior of the structure as it moves up the first angled surface 68, thereby providing for clearance of the locking mechanism 77 from a bottom portion 79 of the lower portion 81 of the upper frame 83 of the window 71 and allowing the window pane unit 75 to be raised the maximal distance until the locking mechanism 77 on the window pane unit 75 abuts a bottom portion 85 of the upper portion 87 of the upper frame 83 of the window 71.

The shim 63 may be included as part of the side frame 69 of the window 71 during manufacture or may be a retrofit unit that is field installed. To install the shim 63, an opening 66 may be made in the side frame 69 of the window 71 by drilling or punching a hole in the side frame 69. The shim 63 may be coupled to the side frame 69 using the screw 65 that may be inserted into the opening 66 or that may be screwed directly into the side frame 69 of the window 71 without the need for prior drilling or punching. Alternatively, a grommet may be inserted through the shim 63 and the opening 66 to secure the shim 63 to the side frame 69.

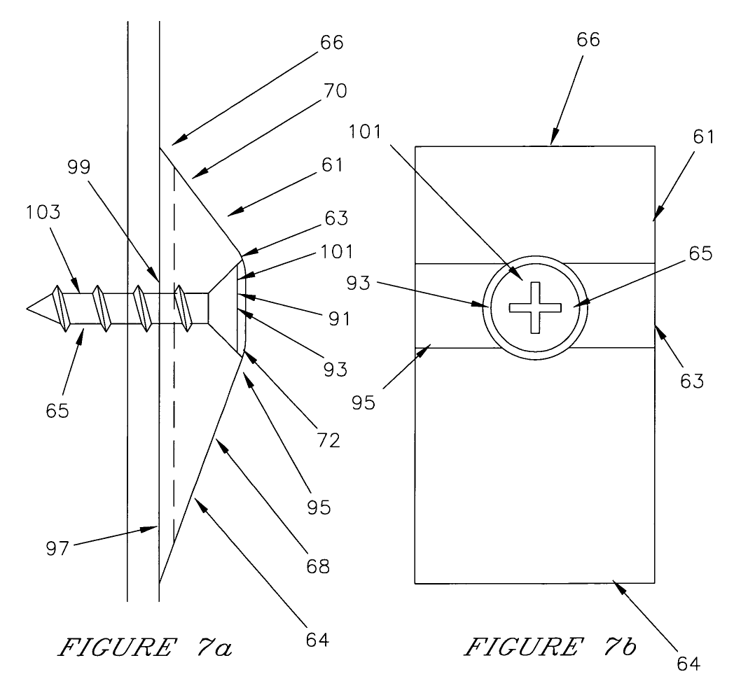

Looking now at FIG. 7a there is shown a side view of the frame ramp of FIG. 4. The frame ramp 61 is in the form of a shim 63 that includes a face portion 91 having a depressed central area 93 where the head 101 of the screw 65 may sit and an elevated circumferential area 95, and a rear portion 97. The face portion includes the lower end 64 with the angled first surface 68 and the upper end 66 with the oppositely angled second surface 70, such that the first surface 68 and the second surface 70 form the peak 72. The shim 63 includes a central channel 99 for insertion of the body 103 of the screw 65. The shim 63 may include an additional pin that may be inserted into a second smaller opening in the side sash so as to maintain the orientation of the shim 63.

In FIG. 7b there is shown a front view of the frame ramp of FIG. 4. The frame ramp 61 in the form of a shim 63 has a rectangular shape with the upper end 66 disposed at the top of the side frame 69 of the window 71 and the lower end 64 disposed at the bottom of the side frame 69 of the window 71. The central area 93 is depressed below the level of the circumferential area 95 so as to provide a recessed area for positioning the head 101 of the screw 65 when it is in a deployed position coupling the shim 63 to the side frame 69.

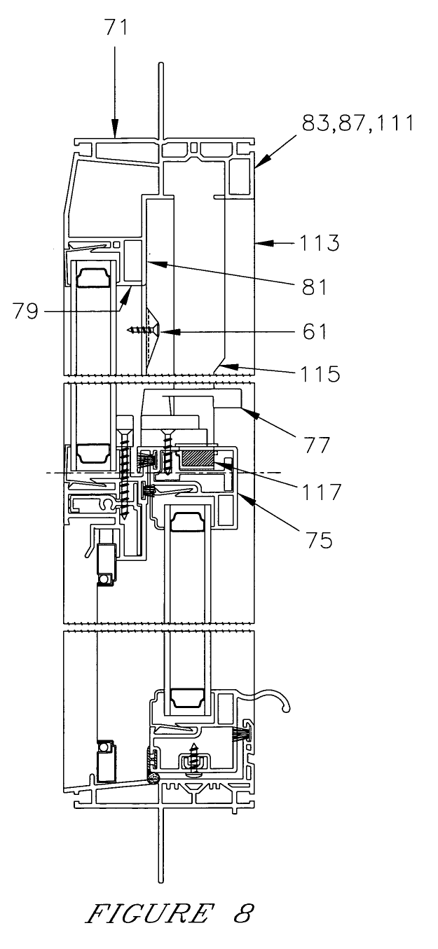

Turning now to FIG. 8, there is shown the window frame of FIG. 6, with an angled side channel. The frame 111 of the window 71 includes side portions 113 (only one shown) that each include a channel 115 for guiding the movement of the window pane unit 75. The window pane unit 75 includes extensions or pins 117 that are each positioned within a channel 115 to ensure stability of the window pane unit 75 and proper movement of the window pane unit 75 along the channels 115. The pins 117 also prevent the window pane unit 75 from intruding within the structure through the force of the wind or other external forces. Each channel 115 extend in a linearly upward direction from the bottom of the side portions 113 of the frame 111 until a point adjacent to the frame ramp 61, at which point the channels 115 are disposed in an upward angular direction running toward the interior of the structure to accommodate a forward movement of the window pane unit 75 toward the interior of the structure. The forward movement of the window pane unit 75 allows the locking mechanism 77 to avoid impinging upon the bottom portion 79 of the lower portion 81 of the upper frame 83 of the window 71 and allows the window pane unit 75 to be raised the maximal distance until the locking mechanism 77 on the window pane unit 75 abuts a bottom portion 85 of the upper portion 87 of the upper frame 83 of the window 71. Alternatively, impingement of the locking mechanism 77 upon the bottom portion 79 of the lower portion 81 of the upper frame 83 of the window 71 may be avoided exclusively through the movement of the window pane unit 75 toward the interior of the structure by the angular movement of the pins 117 in the channels 115 thereby forcing the window pane unit 75 in a direction inward to the structure.

What is claimed is:

1. An apparatus for maximizing a window opening, comprising:
a widow side frame; and
a shim having a first angled surface, coupled to the window side frame.

2. The apparatus according to claim 1, further comprising a window frame having a channel formed therein, a window sash, and a pin coupled to the window sash, wherein the pin is positioned within the channel.

3. The apparatus according to claim 1, wherein the shim is coupled to the window side frame using a screw.

4. The apparatus according to claim 1, wherein the shim is coupled to the window side frame using adhesive.

5. The apparatus according to claim 1, wherein the shim includes a second surface having disposed thereon an extension including a flange.

6. The apparatus according to claim 5, wherein the flange includes legs disposed substantially parallel to the rear surface of the shim.

7. The apparatus according to claim 5, wherein the shim is coupled to the window side frame using the flange.

8. An apparatus for maximizing a window opening, comprising:
a window pane unit;
a window frame having a channel therein, the channel having an angular portion directed away from the plane defined by the window pane unit and toward the interior of a structure in relation to the specified position of the window frame in the structure; and
at least one pin coupled to the window pane unit, the at least one pin positioned within the channel, wherein the pin within the channel assists in guiding the window pane unit.

9. The apparatus according to claim 8, further comprising a window side frame and a shim, the shim coupled to the window side frame.

10. The apparatus according to claim 9, wherein the shim includes a flange and the shim is coupled to the window side frame using the flange.

11. The apparatus according to claim 9, wherein the shim is coupled to the window side frame using a screw.

12. A shim for coupling to a window side frame and maximizing a window opening, comprising:
a first end having at least one angled surface; and
a second end having a flat surface.

13. The shim according to claim 12, wherein the shim includes an aperture running therethrough from the first end to the second end.

14. The shim according to claim 13, wherein the shim is coupled to the window side frame using a screw.

15. The shim according to claim 12, wherein the shim is coupled to the window side frame using adhesive.

16. The shim according to claim 12, wherein the second end includes a flange extending laterally from the second end.

17. The shim according to claim 16, wherein the flange includes legs disposed substantially parallel to the rear surface of the shim.

18. The shim according to claim 16, wherein the shim is coupled to the window side frame using the flange.

19. A method for maximizing a window opening, comprising:
coupling a shim to a window side frame; and
modifying at least one channel in at least one window side frame to provide for forward movement of at least one portion of a window pane unit.

20. The method according to claim 19, wherein the forward movement of the at least one portion of the window pane unit occurs when a top portion of the window pane unit is adjacent to the shim.
